(19) United States
(12) Patent Application Publication
(10) Pub. No.: US 2023/0075725 A1
(43) Pub. Date: Mar. 9, 2023

(54) GLASS COMPOSITION, AND GLASS FIBER AND GLASS ARTICLE INCLUDING THE SAME

(71) Applicant: FULLTECH FIBER GLASS CORP., Douliu City (TW)

(72) Inventors: Hsien-Chung HSU, Douliu City (TW); Bih-Cherng CHERN, Douliu City (TW); Hsiao-Kang CHANG, Douliu City (TW); Chih-Yuan CHANG, Douliu City (TW); Wen-Ho HSU, Douliu City (TW)

(21) Appl. No.: 17/901,486

(22) Filed: Sep. 1, 2022

(30) Foreign Application Priority Data
Sep. 6, 2021 (TW) 110133040

(51) Int. Cl. C03C 3/093; C03C 3/087; C03C 13/00

(52) U.S. Cl. CPC C03C 3/093; C03C 3/087; C03C 13/00

(57) ABSTRACT

Disclosed herein is a glass composition that includes, based on a total weight of the glass composition, 55 wt % to 64 wt % of SiO₂, 15 wt % to 22 wt % of Al₂O₃, 0.1 wt % to 4 wt % of CaO, 2.1 wt % to 10 wt % of MgO, 0 wt % to 8 wt % of ZnO, greater than 0 wt % and less than 7 wt % of CuO, and greater than 13.1 wt % and less than 18 wt % of B₂O₃. Also disclosed herein are a glass fiber and a glass article including the glass composition.

### CROSS-REFERENCE TO RELATED APPLICATION

This application claims priority of Taiwanese Invention Patent Application No. 110133040, filed on Sep. 6, 2021.

### FIELD

The present disclosure relates to a glass composition and a glass fiber including the same.

More particularly, the glass fiber made from the glass composition has a low thermal expansion coefficient, a low dielectric constant and a low dielectric loss tangent. The present disclosure also relates to a glass article including the glass fiber.

### BACKGROUND

Glass fiber is widely used in various electronic products, e.g., circuit boards, wireless access points, etc., due to its advantageous features such as electrical insulation, low dissipation factor, high stability, etc.

Taiwanese Invention Patent Application No. TW 202118743 A discloses a low-dielectric glass composition and a low-dielectric glass fiber. The low-dielectric glass composition includes greater than 49 wt % and not greater than 53 wt % of SiO₂, 13 wt % to 17 wt % of Al₂O₃, 18 wt % to 24 wt % of B₂O₃, greater than 2 wt % and not greater than 4.5 wt % of MgO, greater than 2 wt % and not greater than 5 wt % of CaO, greater than 0.6 wt % and less than 3.5 wt % of TiO₂, greater than 0 wt % and not greater than 0.6 wt % of Na₂O, 0 wt % to 0.5 wt % of K₂O, 0 wt % to wt % of F₂, greater than 1 wt % and less than 4 wt % of ZnO, greater than 0 wt % and not greater than 1 wt % of Fe₂O₃, 0.1 wt % to 0.6 wt % of SO₃, in which a total content of MgO, CaO and ZnO ranges from greater than 8 wt % and less than 11 wt %. The low-dielectric glass fiber is formed from the low-dielectric glass composition.

By virtue of the low-dielectric glass composition including the aforesaid components and the required content ranges of such components, the low-dielectric glass fiber formed from the low-dielectric glass composition is conferred with a low dielectric constant and a low dielectric loss tangent. However, with increasingly complex design of electronic products, in particular the wireless access points, the heat generated during operation of the electronic products would have undesirable effects thereon, or the residual stress caused by thermal expansion or contraction of electronic components during manufacturing would have adverse effects on such electronic components, e.g., peeling occurs due to difference in thermal expansion coefficient between the insulating layer or insulating portion and metal foil/metal line, and thus when the effect of thermal expansion and contraction is taken into account, the requirements for geometric properties (e.g., length or volume) of glass fibers become relatively more stringent. As such, there is an urgent need to develop a glass fiber having a low thermal expansion coefficient and with low dielectric properties (i.e., low dielectric constant and low dielectric loss tangent).

### SUMMARY

Therefore, a first object of the present disclosure is to provide a glass composition which can alleviate at least one of the drawbacks of the prior art.

The glass composition includes, based on a total weight of the glass composition: 55 wt % to 64 wt % of SiO₂, 15 wt % to 22 wt % of Al₂O₃, 0.1 wt % to 4 wt % of CaO, 2.1 wt % to 10 wt % of MgO, 0 wt % to 8 wt % of ZnO, greater than 0 wt % and less than 7 wt % of CuO, and greater than 13.1 wt % and less than 18 wt % of B₂O₃.

A second object of the present disclosure is to provide a glass fiber including a glass composition as described above, which can alleviate at least one of the drawbacks of the prior art.

A third object of the present disclosure is to provide a glass article including a glass fiber as described above, which can alleviate at least one of the drawbacks of the prior art.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which this disclosure belongs. One skilled in the art will recognize many methods and materials similar or equivalent to those described herein, which could be used in the practice of this disclosure. Indeed, this disclosure is in no way limited to the methods and materials described.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some aspects ±100%, in some aspects ±50%, in some aspects ±20%, in some aspects ±10%, in some aspects ±5%, in some aspects ±1%, in some aspects ±0.5%, and in some aspects ±0.1% from the specified amount, as such variations are appropriate to perform the disclosed methods or employ the disclosed compositions.

The present disclosure provides a glass composition including, based on a total weight of the glass composition: 55 wt % to 64 wt % of SiO₂, 15 wt % to 22 wt % of Al₂O₃, 0.1 wt % to 4 wt % of CaO, 2.1 wt % to 10 wt % of MgO, 0 wt % to 8 wt % of ZnO, greater than 0 wt % and less than 7 wt % of CuO, and greater than 13.1 wt % and less than 18 wt % of B₂O₃.

According to the present disclosure, SiO₂ is the main component of the glass composition. The SiO₂ has a three-dimensional network structure, and the basic structural unit of the three-dimensional network structure is the crystal lattice structure of tetrahedral arrangement of SiO₄.

Since SiO₂ is present in an amount ranging from 55 wt % to 64 wt % and Al₂O₃ is present in amount ranging from 15 wt % to 22 wt %, Al₂O₃ is bonded to a portion of oxygen atoms in the three-dimensional network structures of SiO₂ so as to form bridging oxygen, thereby improving thermal stability and viscosity of the glass composition. However, when Al₂O₃ is present in an amount of greater than 22 wt %, the glass composition will have an excessively high viscosity, resulting in the glass composition requiring a high temperature for preparing a glass fiber, thereby incurring a high production cost.

According to the present disclosure, since CaO is present in amount ranging from 0.1 wt % to 4 wt %, the viscosity of the glass composition may be reduced to facilitate sufficient melting of the glass composition during thermal processing. However, when CaO is present in an amount of greater than 4 wt %, the dielectric constant of the glass fiber formed from the glass composition will be increased.

According to the present disclosure, since MgO is present in amount ranging from 2.1 wt % to 10 wt %, the viscosity of the glass composition may be reduced to facilitate sufficient melting of the glass composition during thermal processing and to improve mechanical strength of a glass fiber formed from the glass composition. However, when MgO is present in an amount of greater than 10 wt %, the dielectric constant of the glass fiber formed from the glass composition will be increased.

According to the present disclosure, since ZnO is present in amount ranging from 0 wt % to 8 wt %, ZnO is capable of reducing thermal expansion coefficient of the glass fiber formed from the glass composition. According to the general knowledge of those skilled in the art, when the glass composition includes an alkali metal oxide (e.g., Na₂O or K₂O) and ZnO, the glass fiber formed from the glass composition will have a loose structure, which is not conducive to reducing the thermal expansion coefficient of the glass fiber. Therefore, in certain embodiments, ZnO may be omitted when the glass composition includes the alkali metal oxide.

According to the present disclosure, since CuO is present in an amount of greater than 0 wt % and less than 7 wt %, CuO is capable of reducing thermal expansion coefficient of the glass fiber formed from the glass composition, such that the glass fiber formed from the glass composition tends to have a dense structure, thereby alleviating the problem of the glass fiber having a loose structure caused by the presence of ZnO and the alkali metal oxide. However, in the absence of CuO, the thermal expansion coefficient of the glass composition is greater than 3 ppm/° C.; whereas when CuO is present in an amount of greater than 7 wt %, the glass composition will crystallize, which is not conducive to forming the glass fiber by a spinning process.

According to the present disclosure, since B₂O₃ is present in an amount of greater than 13.1 wt % and less than 18 wt %, the glass composition has a good spinnability, and glass fiber formed from the glass composition are conferred with a low dielectric constant and a low dielectric loss tangent. However, when B₂O₃ is present in an amount of not greater than 13.1 wt %, the dielectric constant of the glass composition under a frequency of 10 GHz is greater than 5; and when B₂O₃ is present in an amount of greater than 18 wt %, the glass composition will crystallize, which is not conducive to forming the glass fiber by a spinning process.

According to the present disclosure, the glass composition further includes an additional component. In certain embodiments, the additional component is selected from the group consisting of Na₂O, K₂O, Fe₂O₃, TiO₂, and combinations thereof. In certain embodiments, the additional component is present in an amount of greater than 0 wt % and not greater than 1.2 wt % based on the total weight of the glass composition.

According to the present disclosure, each of Na₂O and K₂O is used as a fluxing agent. Since Na₂O and/or K₂O is present in an amount of greater than 0 wt % and not greater than 1.2 wt %, the glass composition can be easily melted into a molten glass, which facilitates formation of the glass fiber at a low temperature. However, when Na₂O and/or K₂O is present in an excessively high amount, the glass fiber has a low chemical stability, which results in decreased electrical insulation and mechanical strength thereof.

According to the present disclosure, since Fe₂O₃ is present in an amount of greater than 0 wt % and not greater than 1.2 wt %, Fe₂O₃ may improve stability of the glass composition during formation of the glass fiber by melting, spinning or other processes. However, when Fe₂O₃ is present in an excessively high amount, a problem of uneven temperature distribution may occur during melting of the glass composition.

According to the present disclosure, since TiO₂ is present in an amount of greater than 0 wt % and not greater than 1.2 wt %, TiO₂ may improve the mechanical strength of the glass composition. However, when TiO₂ is present in an excessively high amount, the glass composition will crystallize, which is not conducive to forming the glass fiber by a spinning process.

Further, the present disclosure provides a glass fiber which includes the aforesaid glass composition. The glass fiber has a low thermal expansion coefficient, a low dielectric constant, and a low dielectric loss tangent.

In certain embodiments, the glass fiber has a thermal expansion coefficient of not greater than 3 ppm/° C. In certain embodiments, the glass fiber has a dielectric constant of not greater than 5 under a frequency of 10 GHz. In other embodiments, the glass fiber a dielectric constant of not greater than 0.0045 under a frequency of 10 GHz.

Still further, the present disclosure provides a glass article which includes the glass fiber as described above. The glass article has a low thermal expansion coefficient, a low dielectric constant, and a low dielectric loss tangent.

According to the present disclosure, examples of the glass article may include, but are not limited to, printed circuit board, an integrated circuit board, and a radome. In certain embodiments, the glass article is selected from a printed circuit board, an integrated circuit board, or a radome.

The present disclosure will be further described by way of the following examples. However, it should be understood that the following examples are intended solely for the purpose of illustration and should not be construed as limiting the present disclosure in practice.

### Examples and Comparative Examples

### Preparation of Glass Composition and Glass Specimen

For each of five examples, i.e., Examples 1 to 5 (EX1 to EX5) and five comparative examples, i.e., Comparative Examples 1 to 5 (CE1 to CE5), a glass composition was prepared using the corresponding recipe shown in Table 1 below, and was used to prepare a glass specimen (i.e., a glass block or a glass sheet).

To be specific, all the ingredients listed in the respective recipe shown in Table 1 were evenly mixed to obtain the corresponding glass composition. The glass composition was heated in a high temperature furnace at 1500° C. to 1600° C. for 1 hour to 4 hours. The resultant molten glass was poured into a graphite crucible having a diameter of 40 mm, and the graphite crucible was then placed in an annealing furnace preheated to 800° C. The molten glass was allowed to cool to room temperature, so as to obtain a glass block.

TABLE 1

| Ingredients | | | | | | | | | | |
|---|---|---|---|---|---|---|---|---|---|---|
| of glass | | | | | | | | | | |
| composition | | | | | | | | | | |
| (wt %) | EX1 | EX2 | EX3 | EX4 | EX5 | CE1 | CE2 | CE3 | CE4 | CE5 |
| SiO₂ | 55.21 | 56.21 | 55.16 | 60 | 55.36 | 56.33 | 55.21 | 57 | 56 | 57.3 |
| Al₂O₃ | 19.17 | 19.2 | 18.18 | 20 | 19.18 | 19.17 | 19.17 | 19.2 | 19 | 18.66 |
| CaO | 0.16 | 0.12 | 0.2 | 2 | 0.2 | 0.24 | 0.16 | 0.12 | 3.5 | 0.28 |
| MgO | 4.2 | 3.2 | 0.2 | 3 | 5.2 | 6.2 | 4.3 | 2.2 | 7 | 2.2 |
| ZnO | 6.5 | 6.5 | 6.5 | 0 | 5 | 6.5 | 6.5 | 2 | 0 | 0 |
| CuO | 0.5 | 0.5 | 0.5 | 0.5 | 0.5 | 0.5 | 0.5 | 0.5 | 0 | 7 |
| B₂O₃ | 13.2 | 13.2 | 13.2 | 13.5 | 13.5 | 10 | 13.1 | 18 | 13.5 | 13.5 |
| Na₂O | 0.03 | 0.03 | 0.03 | 0.03 | 0.03 | 0.03 | 0.03 | 0.03 | 0.03 | 0.03 |
| K₂O | 0.03 | 0.03 | 0.03 | 0.03 | 0.03 | 0.03 | 0.03 | 0.03 | 0.03 | 0.03 |
| Fe₂O₃ | 0.32 | 0.33 | 0.32 | 0.32 | 0.32 | 0.32 | 0.32 | 0.31 | 0.32 | 0.32 |
| TiO₂ | 0.68 | 0.68 | 0.68 | 0.62 | 0.68 | 0.68 | 0.68 | 0.61 | 0.62 | 0.68 |

### Property Evaluation

### 1. Thermal Expansion Coefficient

A respective one of the glass blocks of EX1 to EX5 and CE1 to CE5 was cut and ground to obtain a test sample having a size of 0.5 cm×0.5 cm×2 cm. Next, the test sample was subjected to heating using a thermomechanical analyzer (Manufacturer: Hitachi; Model no.: TMA71000) at a heating rate of 10° C./min, and the length of the test sample heated to 50° C. and 200° C. was measured, followed by calculating the changes in the length of the test sample with changes in the temperature thereof, so as to determine thermal expansion coefficient. The results are shown in Table 2.

2. Dielectric Constant (Dₖ) and Dielectric Loss Tangent (D_{f})

A respective one of the glass blocks of EX1 to EX5 and CE1 to CE5 was ground and polished to obtain a glass sheet having a thickness ranging from 0.60 mm to 0.79 mm. Then, the glass sheet was subjected to measurement of dielectric constant and dielectric loss tangent at a frequency of 10 GHz using a vector network analyzer (Manufacturer: Rohde & Schwarz; Model no.: ZNB20) and a split post dielectric resonator (Manufacturer: Waveray Technology Co., Ltd.). The results are shown in Table 2.

### 3. Forming Window

2.25 g of the respective one of the glass blocks of EX1 to EX5 and CE1 to CE5 was heated in a high temperature furnace at a predetermined temperature for 2 hours. Next, the heated glass block was taken out from the high temperature furnace, followed by cooling to room temperature. The crystallization phenomenon in the glass block was visually observed. If crystals were present in the glass block, the predetermined temperature was the devitrification temperature of the glass composition. Forming window of the glass composition (ΔT; unit: ° C.) is calculated by subtracting the devitrification temperature from the temperature at which the glass composition has a viscosity of 1000 poise. The greater the forming window, the more conducive it is for the glass composition to form the glass fiber by a spinning process. The results are shown in Table 2.

TABLE 2

| Property | | | | | | | | | | |
|---|---|---|---|---|---|---|---|---|---|---|
| evaluation | EX1 | EX2 | EX3 | EX4 | EX5 | CE1 | CE2 | CE3 | CE4 | CE5 |
| Thermal | 2.66 | 2.51 | 2.78 | 2.70 | 2.62 | 2.64 | 2.66 | 2.66 | 3.28 | 2.22 |
| expansion | | | | | | | | | | |
| coefficient | | | | | | | | | | |
| Dielectric | 4.98 | 4.94 | 4.98 | 4.82 | 4.95 | 5.15 | 5.03 | 4.66 | 5.04 | 4.7 |
| constant | | | | | | | | | | |
| (Dₓ) at 10 GHz | | | | | | | | | | |
| Dielectric | 0.0041 | 0.0043 | 0.0043 | 0.0038 | 0.0041 | 0.0045 | 0.0041 | 0.0032 | 0.0041 | 0.0067 |
| loss tangent | | | | | | | | | | |
| (Dᵣ) at 10 GHz | | | | | | | | | | |
| Forming | >50 | >50 | >50 | >50 | >50 | — | — | <50 | — | — |
| window, ΔT | | | | | | | | | | |
| (° C.) | | | | | | | | | | |

“—”; cannot be determined

As shown in Tables 1 and 2, when the glass composition included 0 wt % and greater than 7 wt % of CuO (see CE4 and CE5) or included not greater than 13.1 wt % of B₂O₃ (see CE1 and CE2), based on the total weight of the glass composition, the glass sheet or glass block formed from the glass composition had at least one of thermal expansion coefficient, dielectric constant, and dielectric loss tangent that was too high. In contrast, when the glass composition included greater than 0 wt % and not greater than 7 wt % of CuO, and greater than 13.1 wt % and less than 18 wt % of B₂O₃ (see EX1 to EX6), the thermal expansion coefficient, dielectric constant, and dielectric loss tangent of the glass sheet or glass block formed from the glass composition were not greater than 2.8 ppm/° C., not greater than 4.98, and not greater than 0.0043, respectively. These results indicate that the glass fiber formed from the glass composition of the present disclosure, and the glass article including the glass fiber of the present disclosure have a low thermal expansion coefficient, a low dielectric constant and a low dielectric loss tangent.

In addition, although the glass block formed from the glass composition of CE3 had a low thermal expansion coefficient, a low dielectric constant and a low dielectric loss tangent, crystals were present in the glass block due to B₂O₃ being present in an amount of greater than 18 wt %, resulting in a low transparency of the glass block, and when glass fiber is to be formed from the glass composition of CE3, the problem of fiber breakage is likely to occur during the spinning process, resulting in a poor yield of the glass fiber.

In summary, the glass composition of the present disclosure has a good spinnability due to the combination of all the required components (CuC and B₂O₃in particular) and the required contents of these components in the glass composition, such that the glass fiber formed by the glass composition, and the glass article including the glass fiber have a low thermal expansion coefficient, a low dielectric constant, and a low dielectric loss tangent.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A glass composition comprising, based on a total weight of said glass composition:
55 wt % to 64 wt % of SiO₂;
15 wt % to 22 wt % of Al₂O₃;
0.1 wt % to 4 wt % of CaO;
2.1 wt % to 10 wt % of MgO;
0 wt % to 8 wt % of ZnO;
greater than 0 wt % and less than 7 wt % of CuO; and
greater than 13.1 wt % and less than 18 wt % of B₂O₃.

2. The glass composition as claimed in claim 1, further comprising an additional component selected from the group consisting of Na₂O, K₂O, Fe₂O₃, TiO₂, and combinations thereof.

3. The glass composition as claimed in claim 2, wherein said additional component is present in an amount of greater than 0 wt % and not greater than 1.2 wt % based on said total weight of said glass composition.

4. A glass fiber comprising a glass composition as claimed in claim 1.

5. The glass fiber as claimed in claim 4, which has a thermal expansion coefficient of not greater than 3 ppm/° C.

6. The glass fiber as claimed in claim 4, which has a dielectric constant of not greater than 5 under a frequency of 10 GHz.

7. The glass fiber as claimed in claim 4, which has a dielectric loss tangent of not greater than 0.0045 under a frequency of 10 GHz.

8. A glass article comprising a glass fiber as claimed in claim 4.

9. The glass article as claimed in claim 8, which is selected from a printed circuit board, an integrated circuit board, or a radome.

10. A glass fiber comprising a glass composition as claimed in claim 2.

11. The glass fiber as claimed in claim 10, which has a thermal expansion coefficient of not greater than 3 ppm/° C.

12. The glass fiber as claimed in claim 10, which has a dielectric constant of not greater than 5 under a frequency of 10 GHz.

13. The glass fiber as claimed in claim 10, which has a dielectric loss tangent of not greater than 0.0045 under a frequency of 10 GHz.

14. A glass article comprising a glass fiber as claimed in claim 10.

15. The glass article as claimed in claim 14, which is selected from a printed circuit board, an integrated circuit board, or a radome.

16. A glass fiber comprising a glass composition as claimed in claim 3.

17. The glass fiber as claimed in claim 16, which has a thermal expansion coefficient of not greater than 3 ppm/° C.

18. The glass fiber as claimed in claim 16, which has a dielectric constant of not greater than 5 under a frequency of 10 GHz.

19. The glass fiber as claimed in claim 16, which has a dielectric loss tangent of not greater than 0.0045 under a frequency of 10 GHz.

20. A glass article comprising a glass fiber as claimed in claim 16.

21. The glass article as claimed in claim 20, which is selected from a printed circuit board, an integrated circuit board, or a radome.
